(19) United States
(12) Patent Application Publication
(10) Pub. No.: US 2010/0096584 A1
(43) Pub. Date: Apr. 22, 2010

(54) Polishing Composition and Polishing Method Using the Same

(75) Inventor: Fusayo SAEKI, Tualatin, OR (US)

Correspondence Address: VIDAS, ARRETT & STEINKRAUS, P.A., SUITE 400, 6640 SHADY OAK ROAD, EDEN PRAIRIE, MN, 55344, US

(73) Assignee: FUJIMI CORPORATION, Tualatin, OR (US)

(21) Appl. No.: 12/255,775

(22) Filed: Oct. 22, 2008

(51) Int. Cl. C09K 13/04

(52) U.S. Cl. 252/79.2

(57) ABSTRACT

A polishing composition used for chemical mechanical planarization of a substrate containing a noble metal layer is provided. The polishing composition contains positively-charged abrasive particles such as alpha-Al₂O₃ particles, theta-Al₂O₃ particles, delta-Al₂O₃ particles, gamma-Al₂O₃ particles, fumed Al₂O₃ particles, aluminum-modified SiO₂ particles, organosilane-modified SiO₂ particles, CeO₂ particles, TiO₂ particles, and ZrO₂ particles, an inorganic salt such as KCl, RbCl, CsCl, MgCl₂, CaCl₂, SrCl₂, BaCl₂, and NH₄Cl, an oxidizing agent such as H₂O₂, an inorganic acid such as HCl, and water.

### BACKGROUND OF THE INVENTION

The present invention relates to a polishing composition for chemical mechanical planarization of a substrate containing a noble metal layer and to a method for polishing such a substrate using the polishing composition.

Noble metals such as platinum, gold, and palladium have a high resistance to oxidation. A polishing composition for chemical mechanical planarization of a substrate containing a noble metal layer therefore is typically strongly acidic and/or highly oxidizing in order to increase the removal rate of polishing the noble metal layer with the polishing composition. However, a polishing composition being strongly acidic and/or highly oxidizing requires careful handling. There is a need for a polishing composition that has ease of handling and is capable of polishing a noble metal layer at a high removal rate.

### SUMMARY OF THE INVENTION

Accordingly, it is an objective of the present invention to provide a polishing composition that is capable of polishing a noble metal layer at a high removal rate even with containing an acid and/or an oxidizing agent at a low concentration, and to provide a polishing method using the polishing composition.

To achieve the foregoing objective and in accordance with one aspect of the present invention, a polishing composition used for chemical mechanical planarization of a substrate containing a noble metal layer is provided. The polishing composition contains positively-charged abrasive particles, an inorganic salt, an oxidizing agent, an inorganic acid, and water.

In accordance with another aspect of the present invention, a method for polishing a substrate containing a noble metal layer is provided. The method includes preparing the polishing composition according to the above aspect of the present invention and polishing the noble metal layer of the substrate using the polishing composition.

Other aspects and advantages of the invention will become apparent from the following description, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a graph illustrating the zeta potential of aluminum-modified silica particles of 22 nm size in an aqueous solution as a function of the amount of chloride ions in the aqueous solution.

### DETAILED DESCRIPTION OF THE PREFERRED EMBODIMENTS

One embodiment of the present invention will be described below.

A polishing composition according to the embodiment is prepared by mixing positively-charged abrasive particles, an inorganic salt, an oxidizing agent, an inorganic acid, and deionized water. Accordingly, the polishing composition contains positively-charged abrasive particles, an inorganic salt, an oxidizing agent, an inorganic acid, and water.

The polishing composition is used for chemical mechanical planarization of a substrate containing a noble metal layer, a barrier layer, and a dielectric layer. The noble metal layer is made of, but not limited to, platinum, gold, palladium, rhodium, iridium, ruthenium, osmium, or their alloys.

A polishing composition containing positively-charged abrasive particles has a function of mechanically polishing the noble metal layer of the substrate.

Positively-charged abrasive particles to be contained in the polishing composition are preferably, but not limited to, alumina particles such as alpha-alumina particles, theta-alumina particles, delta-alumina particles, gamma-alumina particles, and alumina particles with the mixed crystalline phases, surface-modified alumina particles, ceria particles, surface-modified positively-charged silica particles such as aluminum-, magnesium-, titanium-, zirconium-, and organosilane-modified silica particles, titania particles, zirconia particles, or a mixture thereof.

Positively-charged abrasive particles to be contained in the polishing composition are preferably, but not limited to, colloidal or fumed particles with any shape of the aforementioned abrasive particle types.

The positively-charged abrasive particles are contained in the polishing composition preferably in an amount of 0.01% by mass or more of the polishing composition. The positively-charged abrasive particles are also contained in the polishing composition preferably in an amount of 50% by mass or less of the polishing composition.

An inorganic salt and an oxidizing agent cooperate to increase the removal rate of polishing the noble metal layer of the substrate with a polishing composition containing positively-charged abrasive particles.

An inorganic salt to be contained in the polishing composition is preferably, but not limited to, a salt containing a chloride ion, a salt containing a bromide ion, a salt of a hydroacid, or a mixture thereof. More specifically, an inorganic salt to be contained in the polishing composition is preferably, but not limited to, a chloride salt containing an ammonium ion such as NH₄Cl, a chloride salt containing an alkali metal ion such as KCl, RbCl, and CsCl, a chloride salt containing an alkali earth metal ion such as MgCl₂, CaCl₂, SrCl₂, and BaCl₂, a salt of hydrochloric acid other than the aforementioned chloride salts, a bromide salt containing an ammonium ion such as NH₄Br, a bromide salt containing an alkali metal ion such as KBr, RbBr, and CsBr, a bromide salt containing an alkali earth metal ion such as MgBr₂, CaBr₂, SrBr₂, and BaBr₂, a salt of hydrobromic acid other than the aforementioned bromide salts, a salt of chloroauric acid, a salt of chloroplatinic acid, a salt of bromoauric acid, a salt of bromoplatinic acid, or a mixture thereof.

The inorganic salt is contained in the polishing composition preferably in an amount of 1 μM (μmol/L) or more of the polishing composition. The inorganic salt is also contained in the polishing composition preferably in an amount of 3 M (mol/L) or less of the polishing composition.

An oxidizing agent to be contained in the polishing composition is preferably, but not limited to, ozone, hydrogen peroxide, an alkali metal peroxide, an alkali earth metal peroxide, benzoyl peroxide, ammonium peroxydisulfate, potassium peroxydisulfate, sodium peroxydisulfate, nitrous oxide, an organic peroxyacid, or a mixture thereof.

The oxidizing agent is contained in the polishing composition preferably in an amount of 10 mM (mmol/L) or more of the polishing composition. The oxidizing agent is also contained in the polishing composition preferably in an amount of 3 M (mol/L) or less of the polishing composition.

The inorganic acid is contained in the polishing composition to decrease the pH of the polishing composition and then to increase the zeta potential of the polishing composition. The higher the zeta potential of the abrasive particles in the polishing composition is, the higher the removal rate of polishing the noble metal layer of the substrate with the polishing composition is, in general.

An inorganic acid to be contained in the polishing composition is preferably, but not limited to, hydrochloric acid, chloroauric acid, chloroplatinic acid, hypochlorous acid, chlorous acid, chloric acid, perchloric acid, hydrobromic acid, bromoauric acid, bromoplatinic acid, hypobromous acid, bromous acid, bromic acid, perbromic acid, nitric acid, or a mixture thereof.

The inorganic acid is contained in the polishing composition preferably in an amount such that the polishing composition has an acidic pH.

Next, Examples of the present invention and Comparative Examples and Reference Examples will be described below.

### EXAMPLE A1 AND COMPARATIVE EXAMPLES A1 to A4

A polishing composition according to Example A1 was prepared by mixing alpha-alumina particles as positively-charged abrasive particles, potassium chloride as an inorganic salt, hydrogen peroxide as an oxidizing agent, and hydrochloric acid as an inorganic acid in deionized water. Polishing compositions according to Comparative Example A1 to A4 were prepared by mixing some of alpha-alumina particles (positively-charged abrasive particles) or amorphous silica particles (non-positively charged abrasive particles), potassium chloride, hydrogen peroxide, and hydrochloric acid in deionized water. The details of abrasive particles, potassium chloride, hydrogen peroxide, and hydrochloric acid contained in each polishing composition, and the results of measuring the zeta potential of the polishing compositions are shown in Table 1.

The column entitled “Removal Rate of Pt” in Table 1 shows the results of evaluating the removal rate of polishing a wafer coated with a platinum film by physical vapor deposition and having a diameter of 200 mm with each polishing composition. Polishing was performed under the following conditions:

Polishing machine: Westech 372M

Polishing pad: Politex™ regular pad from Rohm and Haas Electronic Materials (Newark, Del. 19713, U.S.A.)

Polishing downforce: 4 psi (approximately 27.6 kPa)

Platen rotational speed: 80 rpm

Carrier rotational speed: 70 rpm

Slurry feed rate: 200 mL/min.

Polishing duration: 60 sec.

The removal rate of polishing the wafer coated with a platinum film by physical vapor deposition with each polishing composition was evaluated as follows: Four needle electrodes were arranged in a line with a given interval on a wafer. A given current was applied, for example, between the outer two electrodes to detect the potential difference between the two inner electrodes to determine the resistance (R′) there between. The value was then multiplied by a correction factor called a resistivity correction factor (RCF) for sheet resistivity (s′). Sheet resistivity (s) can be determined for a metal film based on the known thickness (T) in nanometers (nm). Sheet resistivity is inversely proportional to the thickness of the film. When the thickness for sheet resistivity of s′ is d, the equation d=(s×T)/.s′ holds. Using this equation, the thickness d can be determined. The difference in thickness before and after polishing was divided by polishing duration to estimate the removal rate. Sheet resistivity reported herein was determined using the ResMap Four Point Probe Resistance Mapping System from Creative Design Engineering, Inc. (Cupertino, Calif. 95014, U.S.A.).

TABLE 1

| | Amount of Abrasive | Type of | Size of | | Amoun | | | |
|---|---|---|---|---|---|---|---|---|
| | Particles | Abrasive | Abrasive | Amount of KCl | t of H₂O₂ | Amount of HCl | Zeta Potential | Removal Rate of Pt |
| Examples | (% by mass) | Particles | (nm) | Particles(mM) | (% by mass) | (% by mass) | (mV) | (Å/min) |
| Ex. A1 | 4 | Alpha-Al₂O₃ | 120 | 500 | 3.4 | 0.035 | +15.0 | 400 |
| Comp. Ex A1 | 0 | N/A | N/A | 500 | 3.4 | 0.035 | N/A | 70 |
| Comp. Ex A2 | 4 | Alpha-Al₂O₃ | 120 | 0 | 3.4 | 0 | +65.0 | 180 |
| Comp. Ex A3 | 10 | Amorphous | 35 | 0 | 3.4 | 0 | −48.0 | 0 |
| | | SiO₂ | | | | | | |
| Comp. Ex A4 | 10 | Amorphous | 35 | 500 | 3.4 | 0.035 | +2.0 | 80 |
| | | SiO₂ | | | | | | |

The results shown in Table 1 indicate that the removal rate of a noble metal with a polishing composition containing an inorganic salt, an oxidizing agent, and an inorganic acid with no abrasive particles is significantly increased by adding positively-charged abrasive particles, as compared with by adding non-positively charged abrasive particles. The results shown in Table 1 also indicate that the removal rate of a noble metal with a polishing composition containing abrasive particles and an oxidizing agent but no inorganic salt and inorganic acid is significantly increased by adding an inorganic salt and an inorganic acid when the abrasive particles are positively-charged abrasive particles, as compared with when the abrasive particles are non-positively charged abrasive particles.

### REFERENCE EXAMPLES B1 TO B19

Polishing compositions according to Reference Examples B1 to B6 were prepared by mixing non-positively charged abrasive particles (amorphous silica particles) or positively-charged abrasive particles (aluminum-modified silica particles, organosilane-modified silica particles, alpha-alumina particles, gamma-alumina particles, or zirconia particles) in deionized water. Polishing compositions according to Reference Examples B7 to B19 were prepared by mixing non-positively charged abrasive particles (amorphous silica particles) or positively-charged abrasive particles (aluminum-modified silica particles, organosilane-modified silica particles, alpha-alumina particles, transitional-alumina particles which are the mixture of the delta- and theta-phases, gamma-alumina particles, ceria particles, or zirconia particles), hydrogen peroxide, and hydrochloric acid in deionized water. The details of abrasive particles, hydrogen peroxide, and hydrochloric acid contained in each polishing composition, and the results of measuring the pH of the polishing compositions are shown in Table 2.

The column entitled “Removal Rate of Pt” and the column entitled “Removal Rate of SiN” in Table 2 show the results of evaluating the removal rate of polishing a wafer coated with a platinum film by physical vapor deposition and having a diameter of 200 mm with each polishing composition and the results of evaluating the removal rate of polishing a silicon nitride wafer having a diameter of 200 mm with each polishing composition, respectively. Polishing was performed under the following conditions:

Polishing machine: Westech 372M

Polishing pad: Politex™ regular pad from Rohm and Haas Electronic Materials

Polishing downforce: 4 psi

Platen rotational speed: 80 rpm

Carrier rotational speed: 70 rpm

Slurry feed rate: 200 mL/min.

Polishing duration: 60 sec.

The removal rate of polishing the wafer coated with a platinum film by physical vapor deposition with each polishing composition was evaluated as in the case of Example A1 and Comparative Examples A1 to A4 described above.

The removal rate of polishing the silicon nitride wafer with each polishing composition was evaluated as follows: The thickness of each silicon nitride wafer was measured optically by Prometric UV1080 from KLA-Tencor (Milpitas, Calif. 95035, U.S.A.) before and after polishing. The difference in thickness before and after polishing was divided by the polishing duration to estimate the removal rate.

The column entitled “Selectivity” in Table 2 shows the ratio of the removal rate of polishing the wafer coated with a platinum film by physical vapor deposition with each polishing composition to the removal rate of polishing the silicon nitride wafer with the same polishing composition. The ratio was estimated by dividing the removal rate of polishing the wafer coated with a platinum film by physical vapor deposition by the removal rate of polishing the silicon nitride wafer.

TABLE 2

| | | | Size of Abrasive | | | | Removal | Removal Rate | |
|---|---|---|---|---|---|---|---|---|---|
| | Particles | Type of Abrasive | Particles | Amount of H₂O₂ | Amount of HCl | | Rate of Pt | of SiN | Selectivity |
| Examples | [symbol] | Particles | (nm) | (% by mass) | (% by mass) | pH | (Å/min) | (Å/min) | (Pt:SiN) |
| Ref. Ex. B1 | 10 | Amorphous SiO₂ | 35 | 0 | 0 | 6.5 | 0 | 80 | 0 |
| Ref. Ex. B2 | 10 | Aluminum-Modified | 22 | 0 | 0 | 4.0 | 10 | 30 | 0.33 |
| | | SiO₂ | | | | | | | |
| Ref. Ex. B3 | 10 | Organosilane-Modified | 85 | 0 | 0 | 5.0 | 20 | 180 | 0.11 |
| | | SiO₂ | | | | | | | |
| Ref. Ex. B4 | 2 | Alpha-Al₂O₃ | 120 | 0 | 0 | 4.0 | 40 | 160 | 0.25 |
| Ref. Ex. B5 | 2 | Gamma-Al₂O₃ | 110 | 0 | 0 | 5.0 | 40 | 90 | 0.44 |
| Ref. Ex. B6 | 4 | ZrO₂ | 160 | 0 | 0 | 4.3 | 30 | 2030 | 0.015 |
| Ref. Ex. B7 | 10 | Amorphous SiO₂ | 35 | 3.4 | 0.035 | 2.1 | 0 | 300 | 0 |
| Ref. Ex. B8 | 10 | Amorphous SiO₂ | 100 | 3.4 | 0.035 | 2.1 | 0 | 570 | 0 |
| Ref. Ex. B9 | 10 | Aluminum-Modified | 22 | 3.4 | 0.035 | 3.5 | 110 | 45 | 2.44 |
| | | SiO₂ | | | | | | | |
| Ref. Ex. B10 | 10 | Aluminum-Modified | 35 | 3.4 | 0.035 | 3.5 | 100 | 90 | 1.11 |
| | | SiO₂ | | | | | | | |
| Ref. Ex. B11 | 10 | Organosilane-Modified | 85 | 3.4 | 0.035 | 3.4 | 150 | 180 | 0.83 |
| | | SiO₂ | | | | | | | |
| Ref. Ex. B12 | 2 | Alpha-Al₂O₃ | 120 | 3.4 | 0.035 | 2.1 | 90 | 30 | 3 |
| Ref. Ex. B13 | 2 | Alpha-Al₂O₃ | 110 | 3.4 | 0.035 | 2.1 | 180 | 30 | 6 |
| Ref. Ex. B14 | 2 | Transitional-Al₂O₃ | 100 | 3.4 | 0.035 | 2.4 | 130 | 15 | 8.67 |
| Ref. Ex. B15 | 2 | Transitional-Al₂O₃ | 53 | 3.4 | 0.035 | 3.9 | 120 | 50 | 2.4 |
| Ref. Ex. B16 | 2 | Gamma-Al₂O₃ | 110 | 3.4 | 0.035 | 3.2 | 100 | 25 | 4 |
| Ref. Ex. B17 | 4 | CeO₂ | 75 | 3.4 | 0.035 | 2.1 | 60 | 5 | 12 |
| Ref. Ex. B18 | 4 | CeO₂ | 100 | 3.4 | 0.035 | 2.2 | 150 | 35 | 4.29 |
| Ref. Ex. B19 | 4 | ZrO₂ | 160 | 3.4 | 0.035 | 2.2 | 120 | 680 | 0.18 |

[symbol]

indicates data missing or illegible when filed

The results shown in Table 2 indicate that the removal rate of a noble metal with a polishing composition containing positively-charged abrasive particles is significantly increased by adding an oxidizing agent and an inorganic acid, while the removal rate of silicon nitride with the same polishing composition is not significantly increased or not increased at all or is even decreased by adding an oxidizing agent and an inorganic acid. The results shown in Table 2 also indicate that while the removal rate of silicon nitride with a polishing composition containing non-positively charged abrasive particles is significantly increased by adding an oxidizing agent and an inorganic acid, the removal rate of a noble metal with the same polishing composition is not increased at all by adding an oxidizing agent and an inorganic acid. The results shown in Table 2 also indicate that the selectivity of the removal rate of a noble metal to the removal rate of silicon nitride is increased by adding an oxidizing agent and an inorganic acid to a polishing composition containing positively-charged abrasive particles.

### EXAMPLES C1 TO C5

Polishing compositions according to Examples C1 to C5 were prepared by mixing alpha-alumina particles as positively-charged abrasive particles, potassium chloride as an inorganic salt, hydrogen peroxide as an oxidizing agent, and hydrochloric acid as an inorganic acid in deionized water. The details of abrasive particles, potassium chloride, hydrogen peroxide, and hydrochloric acid contained in each polishing composition are shown in Table 3.

The column entitled “Removal Rate of Pt” in Table 3 shows the results of evaluating the removal rate of polishing a wafer coated with a platinum film by physical vapor deposition and having a diameter of 200 mm with each polishing composition. Polishing was performed under the following conditions:

Polishing machine: Westech 372M

Polishing pad: Politex™ regular pad from Rohm and Haas Electronic Materials

Polishing downforce: 4 psi

Platen rotational speed: 80 rpm

Carrier rotational speed: 70 rpm

Slurry feed rate: 200 mL/min.

Polishing duration: 60 sec.

The removal rate of polishing the wafer coated with a platinum film by physical vapor deposition with each polishing composition was evaluated as in the case of Example A1 and Comparative Examples A1 to A4 described above.

TABLE 3

| | Particles | Type of | Size of Abrasive | Amount of KCl | Amount of H₂O₂ | Amount of HCl | Removal Rate of Pt |
|---|---|---|---|---|---|---|---|
| Examples | [symbol] | Abrasive Particles | Particles (nm) | (M) | (% by mass) | (% by mass) | (Å/min) |
| Ex. C1 | 3 | Alpha-Al₂O₃ | 110 | 1 | 3.4 | 0.035 | 850 |
| Ex. C2 | 3 | Alpha-Al₂O₃ | 110 | 0.5 | 3.4 | 0.035 | 760 |
| Ex. C3 | 2 | Alpha-Al₂O₃ | 110 | 0.5 | 3.4 | 0.035 | 600 |
| Ex. C4 | 1 | Alpha-Al₂O₃ | 110 | 0.5 | 3.4 | 0.035 | 530 |
| Ex. C5 | 1 | Alpha-Al₂O₃ | 110 | 0.1 | 3.4 | 0.035 | 440 |

[symbol]

indicates data missing or illegible when filed

The results shown in Table 3 indicate that the removal rate of a noble metal with a polishing composition containing alpha-alumina particles, an inorganic salt, an oxidizing agent, and an inorganic acid is increased with increasing the amount of the inorganic salt. The results shown in Table 3 also indicate that the removal rate of a noble metal with the polishing composition is increased with increasing the amount of the alpha-alumina particles.

### EXAMPLES D1 TO D5

Polishing compositions according to Examples D1 to D5 were prepared by mixing aluminum-modified silica particles as positively-charged abrasive particles, potassium chloride as an inorganic salt, hydrogen peroxide as an oxidizing agent, and hydrochloric acid as an inorganic acid in deionized water. The details of abrasive particles, potassium chloride, hydrogen peroxide, and hydrochloric acid contained in each polishing composition are shown in Table 4.

The column entitled “Removal Rate of Pt” and the column entitled “Removal Rate of SiN” in Table 4 show the results of evaluating the removal rate of polishing a wafer coated with a platinum film by physical vapor deposition and having a diameter of 200 mm with each polishing composition and the results of evaluating the removal rate of polishing a silicon nitride wafer having a diameter of 200 mm with each polishing composition, respectively. Polishing was performed under the following conditions:

Polishing machine: Westech 372M

Polishing pad: Politex™ regular pad from Rohm and Haas Electronic Materials

Polishing downforce: 4 psi

Platen rotational speed: 80 rpm

Carrier rotational speed: 70 rpm

Slurry feed rate: 200 mL/min.

Polishing duration: 60 sec.

The removal rate of polishing the wafer coated with a platinum film by physical vapor deposition with each polishing composition was evaluated as in the case of Example A1 and Comparative Examples A1 to A4 described above. The removal rate of polishing the silicon nitride wafer with each polishing composition was evaluated as in the case of Examples B1 to B15 described above.

The column entitled “Selectivity” in Table 4 shows the ratio of the removal rate of polishing the wafer coated with a platinum film by physical vapor deposition with each polishing composition to the removal rate of polishing the silicon nitride wafer with the same polishing composition. The ratio was estimated by dividing the removal rate of polishing the wafer coated with a platinum film by physical vapor deposition by the removal rate of polishing the silicon nitride wafer.

TABLE 4

| | | | Size of | | | | | | |
|---|---|---|---|---|---|---|---|---|---|
| | | Type of | Abrasive | | | | Removal | Removal | |
| | Particles | Abrasive | Particles | Amount of KCl | Amount of H₂O₂ | Amount of HCl | Rate of Pt | Rate of SiN | Selectivity |
| Examples | [symbol] | Particles | (nm) | (mM) | (% by mass) | (% by mass) | (Å/min) | (Å/min) | (Pt:SiN) |
| Ex. D1 | 5 | Aluminum-Modified | 22 | 5 | 1.7 | 0.035 | 90 | 35 | 2.6 |
| | | SiO₂ | | | | | | | |
| Ex. D2 | 5 | Aluminum-Modified | 22 | 5 | 5.1 | 0.035 | 130 | 45 | 2.9 |
| | | SiO₂ | | | | | | | |
| Ex. D3 | 5 | Aluminum-Modified | 22 | 500 | 1.7 | 0.035 | 30 | 60 | 0.5 |
| | | SiO₂ | | | | | | | |
| Ex. D4 | 5 | Aluminum-Modified | 22 | 500 | 5.1 | 0.035 | 70 | 60 | 1.2 |
| | | SiO₂ | | | | | | | |
| Ex. D5 | 5 | Aluminum-Modified | 22 | 50 | 3.4 | 0.035 | 100 | 40 | 2.5 |
| | | SiO₂ | | | | | | | |

[symbol]

indicates data missing or illegible when filed

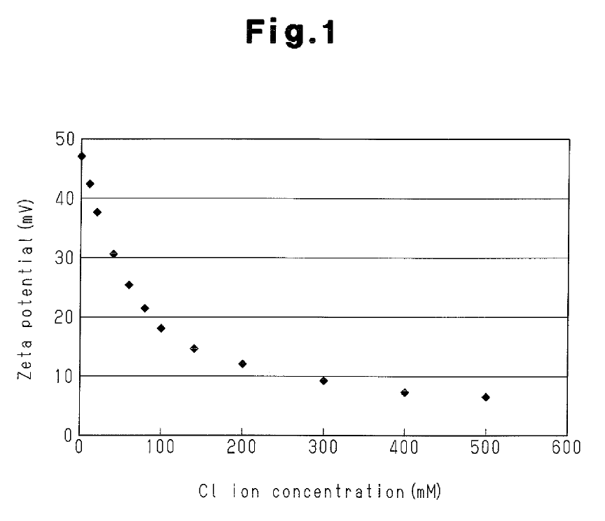

The results shown in Table 4 indicate that the removal rate of a noble metal with a polishing composition containing aluminum-modified silica particles, an inorganic salt, an oxidizing agent, and an inorganic acid is increased with decreasing the amount of the inorganic salt, while the removal rate of silicon nitride with the same polishing composition is decreased with decreasing the amount of the inorganic salt. The reason why the removal rate of a noble metal with the polishing composition is increased with decreasing the amount of the inorganic salt is probable to be that the zeta potential of aluminum-modified silica particles in an aqueous solution increases with decreasing the amount of chloride ions in the aqueous solution as shown in FIG. 1.

A typical commercially available aqueous suspension of aluminum-modified silica particles, such as Ludox® CL-P from Grace Davison and Bindzil CAT80 from Eka Chemicals, contains a significant amount of chloride ions in the suspension. Therefore, when such a suspension is used in preparing a polishing composition, it is not necessary to include additional chloride ions from an inorganic salt in the polishing composition in order that the removal rate of a noble metal with the polishing composition is increased.

The results shown in Table 4 also indicate that the removal rate of a noble metal with a polishing composition containing aluminum-modified silica particles, an inorganic salt, an oxidizing agent, and an inorganic acid is more increased with increasing the amount of the oxidizing agent, as compared with the removal rate of silicon nitride with the same polishing composition being increased with increasing the amount of the oxidizing agent.

### EXAMPLES E1 TO E9

Polishing compositions according to Examples E1 to E9 were prepared by mixing gamma-alumina particles as positively-charged abrasive particles, potassium chloride as an inorganic salt, hydrogen peroxide as an oxidizing agent, and hydrochloric acid as an inorganic acid in deionized water. The details of abrasive particles, potassium chloride, hydrogen peroxide, and hydrochloric acid contained in each polishing composition are shown in Table 5.

The column entitled “Removal Rate of Pt” and the column entitled “Removal Rate of SiN” in Table 5 show the results of evaluating the removal rate of polishing a wafer coated with a platinum film by physical vapor deposition and having a diameter of 200 mm with each polishing composition and the results of evaluating the removal rate of polishing a silicon nitride wafer having a diameter of 200 mm with each polishing composition, respectively. Polishing was performed under the following conditions:

Polishing machine: Westech 372M

Polishing pad: Politex™ regular pad from Rohm and Haas Electronic Materials

Polishing downforce: 4 psi

Platen rotational speed: 80 rpm

Carrier rotational speed: 70 rpm

Slurry feed rate: 200 mL/min.

Polishing duration: 60 sec.

The removal rate of polishing the wafer coated with a platinum film by physical vapor deposition with each polishing composition was evaluated as in the case of Example A1 and Comparative Examples A1 to A4 described above. The removal rate of polishing the silicon nitride wafer with each polishing composition was evaluated as in the case of Examples B1 to B15 described above.

The column entitled “Selectivity” in Table 5 shows the ratio of the removal rate of polishing the wafer coated with a platinum film by physical vapor deposition with each polishing composition to the removal rate of polishing the silicon nitride wafer with the same polishing composition. The ratio was estimated by dividing the removal rate of polishing the wafer coated with a platinum film by physical vapor deposition by the removal rate of polishing the silicon nitride wafer.

TABLE 5

| | | Type of | Size of | | Amount | | Removal Rate | Removal | |
|---|---|---|---|---|---|---|---|---|---|
| | Particles | Abrasive | Abrasive | Amount of KCl | of H₂O₂ | Amount of HCl | of Pt | Rate of SiN | Selectivity |
| Examples | [symbol] | Particles | Particles (nm) | (mM) | (% by mass) | (% by mass) | (Å/min) | (Å/min) | (Pt:SiN) |
| Ex. E1 | 4 | Gamma-Al₂O₃ | 110 | 0.5 | 1 | 0.035 | 120 | 110 | 1 |
| Ex. E2 | 2 | Gamma-Al₂O₃ | 110 | 0.1 | 0.5 | 0.035 | 110 | 70 | 1.6 |
| Ex. E3 | 2 | Gamma-Al₂O₃ | 110 | 2.5 | 0.5 | 0.035 | 90 | 80 | 1.1 |
| Ex. E4 | 6 | Gamma-Al₂O₃ | 110 | 0.1 | 0.5 | 0.035 | 190 | 140 | 1.4 |
| Ex. E5 | 6 | Gamma-Al₂O₃ | 110 | 2.5 | 0.5 | 0.035 | 90 | 190 | 0.5 |
| Ex. E6 | 2 | Gamma-Al₂O₃ | 110 | 0.1 | 1.5 | 0.035 | 170 | 70 | 2.4 |
| Ex. E7 | 2 | Gamma-Al₂O₃ | 110 | 2.5 | 1.5 | 0.035 | 120 | 80 | 1.5 |
| Ex. E8 | 6 | Gamma-Al₂O₃ | 110 | 0.1 | 1.5 | 0.035 | 180 | 130 | 1.4 |
| Ex. E9 | 6 | Gamma-Al₂O₃ | 110 | 2.5 | 1.5 | 0.035 | 80 | 150 | 0.5 |

[symbol]

indicates data missing or illegible when filed

The results shown in Table 5 indicate that the removal rate of a noble metal with a polishing composition containing gamma-alumina particles, an inorganic salt, an oxidizing agent, and an inorganic acid is increased with decreasing the amount of the inorganic salt, while the removal rate of silicon nitride with the same polishing composition is decreased with decreasing the amount of the inorganic salt.

### EXAMPLES F1 TO F7

Polishing compositions according to Examples F1 to F7 were prepared by mixing gamma-alumina particles as positively-charged abrasive particles, an inorganic salt, hydrogen peroxide as an oxidizing agent, and hydrochloric acid as an inorganic acid in deionized water. The details of abrasive particles, an inorganic salt, hydrogen peroxide, and hydrochloric acid contained in each polishing composition are shown in Table 6.

The column entitled “Removal Rate of Pt” in Table 6 show the results of evaluating the removal rate of polishing a wafer coated with a platinum film by physical vapor deposition and having a diameter of 200 mm with each polishing composition. Polishing was performed under the following conditions:

Polishing machine: Westech 372M

Polishing pad: Politex™ regular pad from Rohm and Haas Electronic Materials

Polishing downforce: 4 psi

Platen rotational speed: 80 rpm

Carrier rotational speed: 70 rpm

Slurry feed rate: 200 mL/min.

Polishing duration: 60 sec.

The removal rate of polishing the wafer coated with a platinum film by physical vapor deposition with each polishing composition was evaluated as in the case of Example A1 and Comparative Examples A1 to A4 described above.

TABLE 6

| | [symbol] | Type of | Size of | Amount of | | | | Removal |
|---|---|---|---|---|---|---|---|---|
| | Particles | Abrasive | Abrasive | Inorganic | Type of | Amount of H₂O₂ | Amount of HCl | Rate of Pt |
| Examples | (% by mass) | Particles | Particles (nm) | Salt (mM) | Inorganic Salt | (% by mass) | (% by mass) | (Å/min) |
| Ex. F1 | 2 | Gamma-Al₂O₃ | 120 | 100 | KCl | 3.4 | 0.035 | 160 |
| Ex. F2 | 2 | Gamma-Al₂O₃ | 120 | 100 | CsCl | 3.4 | 0.035 | 160 |
| Ex. F3 | 2 | Gamma-Al₂O₃ | 120 | 100 | (NH₄)Cl | 3.4 | 0.035 | 50 |
| Ex. F4 | 2 | Gamma-Al₂O₃ | 120 | 50 | MgCl₂ | 3.4 | 0.035 | 200 |
| Ex. F5 | 2 | Gamma-Al₂O₃ | 120 | 50 | CaCl₂ | 3.4 | 0.035 | 180 |
| Ex. F6 | 2 | Gamma-Al₂O₃ | 120 | 50 | SrCl₂ | 3.4 | 0.035 | 190 |
| Ex. F7 | 2 | Gamma-Al₂O₃ | 120 | 50 | BaCl₂ | 3.4 | 0.035 | 230 |

[symbol]

indicates data missing or illegible when filed

The results shown in Table 6 indicate that the removal rate of a noble metal with a polishing composition containing positively-charged abrasive particles, an inorganic salt containing an alkali earth metal counterion, an oxidizing agent, and an inorganic acid is higher than that with a polishing composition containing positively-charged abrasive particles, an inorganic salt containing an alkali metal counterion or an ammonium counterion, an oxidizing agent, and an inorganic acid.

### EXAMPLES G1 AND G2

A polishing composition according to Example G1 was prepared by mixing aluminum-modified silica particles as positively-charged abrasive particles, potassium chloride as an inorganic salt, hydrogen peroxide as an oxidizing agent, and hydrochloric acid as an inorganic acid in deionized water. A polishing composition according to Example G2 was prepared by mixing aluminum-modified silica particles and alpha-alumina particles as positively-charged abrasive particles, potassium chloride as an inorganic salt, hydrogen peroxide as an oxidizing agent, and hydrochloric acid as an inorganic acid in deionized water. The details of abrasive particles, potassium chloride, hydrogen peroxide, and hydrochloric acid contained in each polishing composition are shown in Table 7.

The column entitled “Removal Rate of Pt” in Table 7 shows the results of evaluating the removal rate of polishing a wafer coated with a platinum film by physical vapor deposition and having a diameter of 200 mm with each polishing composition. Polishing was performed under the following conditions:

Polishing machine: Westech 372M

Polishing pad: Politex™ regular pad from Rohm and Haas Electronic Materials

Polishing downforce: 4 psi

Platen rotational speed: 80 rpm

Carrier rotational speed: 70 rpm

Slurry feed rate: 200 mL/min.

Polishing duration: 60 sec.

The removal rate of polishing the wafer coated with a platinum film by physical vapor deposition with each polishing composition was evaluated as in the case of Example A1 and Comparative Examples A1 to A4 described above.

TABLE 7

| | Amount of Abrasive | | Size of | | | Amount | |
|---|---|---|---|---|---|---|---|
| | Particles | | Abrasive | Amount of KCl | Amount of H₂O₂ | of HCl | Removal Rate of Pt |
| Examples | (% by mass) | Type of Abrasive Particles | Particles (nm) | (mM) | (% by mass) | (% by mass) | (Å/min) |
| Ex. G1 | 10 | Aluminum-Modified SiO₂ | 35 | 500 | 3.4 | 0.18 | 200 |
| Ex. G2 | 10 | Aluminum-Modified SiO₂ | 35 | 500 | 3.4 | 0.18 | 250 |
| | 1 | Alpha-Al₂O₃ | 120 | | | | |

The results shown in Table 7 indicate that the removal rate of a noble metal with a polishing composition containing aluminum-modified silica particles, an inorganic salt, an oxidizing agent, and an inorganic acid is increased by adding alpha-alumina particles.

### EXAMPLE H1

A polishing composition according to Example H1 was prepared by mixing alpha-alumina particles as positively-charged abrasive particles, potassium chloride as an inorganic salt, hydrogen peroxide as an oxidizing agent, and hydrochloric acid as an inorganic acid in deionized water. The details of abrasive particles, potassium chloride, hydrogen peroxide, and hydrochloric acid contained in the polishing composition are shown in Table 8.

The column entitled “Removal Rate of Pt”, the column entitled “Removal Rate of Pd”, and the column entitled “Removal Rate of Ru” in Table 8 show the results of evaluating the removal rate of polishing a wafer coated with a platinum film by physical vapor deposition and having a diameter of 200 mm with the polishing composition, the results of evaluating the removal rate of polishing a wafer coated with a palladium film by physical vapor deposition and having a diameter of 200 mm with the polishing composition, and the results of evaluating the removal rate of polishing a wafer coated with a ruthenium film by physical vapor deposition and having a diameter of 200 mm with the polishing composition, respectively. Polishing was performed under the following conditions:

Polishing machine: Westech 372M

Polishing pad: IC1000™ pad from Rohm and Haas Electronic Materials

Polishing downforce: 2 psi

Platen rotational speed: 80 rpm

Carrier rotational speed: 70 rpm

Slurry feed rate: 200 mL/min.

Polishing duration: 60 sec.

The removal rate of polishing the wafer coated with a platinum film by physical vapor deposition with the polishing composition was evaluated as in the case of Example A1 and Comparative Examples A1 to A4 described above. The removal rate of polishing the wafer coated with a palladium film by physical vapor deposition with the polishing composition and the removal rate of polishing the wafer coated with a ruthenium film by physical vapor deposition with the polishing composition were evaluated in the same manner as the removal rate of polishing the wafer coated with a platinum film by physical vapor deposition.

TABLE 8

| | | Type of | Size of | Amount | Amount | | Removal | Removal | Removal |
|---|---|---|---|---|---|---|---|---|---|
| | Particles | Abrasive | Abrasive | of KCl | of H₂O₂ | Amount of HCl | Rate of Pt | Rate of Pd | Rate of Ru |
| Examples | [symbol] | Particles | Particles (nm) | (mM) | (% by mass) | (% by mass) | (Å/min) | (Å/min) | (Å/min) |
| Ex. H1 | 4 | Alpha-Al₂O₃ | 100 | 500 | 3.4 | 0.035 | 350 | 1800 | 2000 |

[symbol]

indicates data missing or illegible when filed

The results shown in Table 8 indicate that the removal rate of palladium with a polishing composition containing positively-charged abrasive particles, an inorganic salt, an oxidizing agent, and an inorganic acid is higher than the removal rate of platinum with the same polishing composition. The results shown in Table 8 also indicate that the removal rate of ruthenium with a polishing composition containing positively-charged abrasive particles, an inorganic salt, an oxidizing agent, and an inorganic acid is higher than the removal rate of platinum or palladium with the same polishing composition.

### EXAMPLES I1 TO I4 AND COMPARATIVE EXAMPLES I1

Polishing compositions according to Examples I1 to I4 were prepared by mixing aluminum-modified silica particles, alpha-alumina particles, or fumed alumina particles as positively-charged abrasive particles, potassium chloride as an inorganic salt, hydrogen peroxide as an oxidizing agent, and hydrochloric acid as an inorganic acid in deionized water. A polishing composition according to Comparative Example I1 was prepared by mixing amorphous silica particles (non-positively charged abrasive particles), potassium chloride, hydrogen peroxide, and hydrochloric acid in deionized water. The details of abrasive particles, potassium chloride, hydrogen peroxide, and hydrochloric acid contained in each polishing composition are shown in Table 9.

The column entitled “Removal Rate of Pd” in Table 9 shows the results of evaluating the removal rate of polishing a wafer coated with a palladium film by physical vapor deposition and having a diameter of 200 mm with each polishing composition. Polishing was performed under the following conditions:

Polishing machine: Westech 372M

Polishing pad: IC1000™ pad from Rohm and Haas Electronic Materials

Polishing downforce: 5 psi (approximately 34.5 kPa)

Platen rotational speed: 95 rpm

Carrier rotational speed: 90 rpm

Slurry feed rate: 200 mL/min.

Polishing duration: 30 sec.

The removal rate of polishing the wafer coated with a palladium film by physical vapor deposition with each polishing composition was evaluated as in the case of Example H1 described above.

TABLE 9

| | | | | Amount | | | |
|---|---|---|---|---|---|---|---|
| | Particles | Type of Abrasive | Size of Abrasive | of KCl | Amount of H₂O₂ | Amount of HCl | Removal Rate of Pd |
| Examples | [symbol] | Particles | Particles (nm) | (mM) | (% by mass) | (% by mass) | (Å/min) |
| Ex. I1 | 5 | Aluminum-Modified | 35 | 500 | 3.4 | 0.035 | 390 |
| | | SiO₂ | | | | | |
| Ex. I2 | 5 | Aluminum-Modified | 22 | 5 | 3.4 | 0.035 | 570 |
| | | SiO₂ | | | | | |
| Ex. I3 | 4 | Alpha-Al₂O₃ | 100 | 500 | 3.4 | 0.035 | 2300 |
| Ex. I4 | 2 | Fumed Al₂O₃ | 120 | 500 | 3.4 | 0.035 | 740 |
| Comp. Ex. I1 | 5 | Amorphous SiO₂ | 35 | 500 | 3.4 | 0.035 | 120 |

[symbol]

indicates data missing or illegible when filed

The results shown in Table 9 indicate that the removal rate of a noble metal with a polishing composition containing positively-charged abrasive particles, an inorganic salt, an oxidizing agent, and an inorganic acid is higher than the removal rate of a noble metal with a polishing composition containing non-positively charged abrasive particles, an inorganic salt, an oxidizing agent, and an inorganic acid.

### EXAMPLES J1 TO J5

Polishing compositions according to Examples J1 to J5 were prepared by mixing alpha-alumina particles as positively-charged abrasive particles, potassium chloride as an inorganic salt, hydrogen peroxide as an oxidizing agent, and hydrochloric acid as an inorganic acid in deionized water. The details of abrasive particles, potassium chloride, hydrogen peroxide, and hydrochloric acid contained in each polishing composition are shown in Table 10.

The column entitled “Removal Rate of Pd” in Table 10 shows the results of evaluating the removal rate of polishing a wafer coated with a palladium film by physical vapor deposition and having a diameter of 200 mm with each polishing composition. Polishing was performed under the following conditions:

Polishing machine: Westech 372M

Polishing pad: IC1000™ pad from Rohm and Haas Electronic Materials

Polishing downforce: 5 psi

Platen rotational speed: 95 rpm

Carrier rotational speed: 90 rpm

Slurry feed rate: 200 mL/min.

Polishing duration: 30 sec.

The removal rate of polishing the wafer coated with a palladium film by physical vapor deposition with each polishing composition was evaluated as in the case of Example H1 described above.

TABLE 10

| | [symbol] | | | | | | |
|---|---|---|---|---|---|---|---|
| | Particles | Type of Abrasive | Size of Abrasive | Amount of KCl | Amount of H₂O₂ | Amount of HCl | Removal Rate of Pd |
| Examples | (% by mass) | Particles | Particles (nm) | (mM) | (% by mass) | (% by mass) | (Å/min) |
| Ex. J1 | 4 | Alpha-Al₂O₃ | 100 | 500 | 3.4 | 0.035 | 2300 |
| Ex. J2 | 2 | Alpha-Al₂O₃ | 100 | 250 | 3.4 | 0.018 | 2000 |
| Ex. J3 | 1 | Alpha-Al₂O₃ | 100 | 125 | 3.4 | 0.009 | 1500 |
| Ex. J5 | 0.4 | Alpha-Al₂O₃ | 100 | 50 | 3.4 | 0.005 | 1100 |
| Ex. J5 | 0.4 | Alpha-Al₂O₃ | 100 | 250 | 3.4 | 0.035 | 2000 |

[symbol]

indicates data missing or illegible when filed

The results shown in Table 10 indicate that the removal rate of a noble metal with a polishing composition containing positively-charged abrasive particles, an inorganic salt, an oxidizing agent, and an inorganic acid is increased with increasing the amounts of the positively-charged abrasive particles, the inorganic salt, and the inorganic acid. The results shown in Table 10 also indicate that the removal rate of a noble metal with a polishing composition containing a given amount of positively-charged abrasive particles is increased with the increasing amounts of the inorganic salt and the inorganic acid.

### EXAMPLE K1

A polishing composition according to Example K1 was prepared by mixing alpha-alumina particles as positively-charged abrasive particles, potassium chloride as an inorganic salt, hydrogen peroxide as an oxidizing agent, and hydrochloric acid as an inorganic acid in deionized water. The details of abrasive particles, potassium chloride, hydrogen peroxide, and hydrochloric acid contained in the polishing composition are shown in Table 11.

The column entitled “Removal Rate of Pd at polishing downforce of 2 psi” and the column entitled “Removal Rate of Pd at polishing downforce of 5 psi” in Table 11 show the results of evaluating the removal rate of polishing a wafer coated with a palladium film by physical vapor deposition and having a diameter of 200 mm with the polishing composition at a polishing downforce of 2 psi (approximately 13.8 kpa)and the results of evaluating the removal rate of polishing the same wafer with the polishing composition at a polishing downforce of 5 psi (approximately 34.5 kPa), respectively. Polishing was performed under the following conditions:

Polishing machine: Westech 372M

Polishing pad: IC1000™ pad from Rohm and Haas Electronic Materials

Platen rotational speed: 95 rpm

Carrier rotational speed: 90 rpm

Slurry feed rate: 200 mL/min.

Polishing duration: 30 sec.

The removal rate of polishing the wafer coated with a palladium film by physical vapor deposition with the polishing composition was evaluated as in the case of Example H1 described above.

TABLE 11

| | | Type of | Size of | Amount | Amount | | polishing | polishing |
|---|---|---|---|---|---|---|---|---|
| | Particles | Abrasive | Abrasive | of KCl | of H₂O₂ | Amount of HCl | downforce | downforce |
| Examples | [symbol] | Particles | Particles (nm) | (mM) | (% by mass) | (% by mass) | of 2 psi | of 5 psi |
| Ex. K1 | 0.4 | Alpha-Al₂O₃ | 100 | 250 | 3.4 | 0.035 | 1500 | 2000 |

[symbol]

indicates data missing or illegible when filed

The results shown in Table 11 indicate that the removal rate of a noble metal with a polishing composition containing positively-charged abrasive particles, an inorganic salt, an oxidizing agent, and an inorganic acid is increased with increasing polishing downforce.

1. A polishing composition used for chemical mechanical planarization of a substrate containing a noble metal layer, the polishing composition comprising:
positively-charged abrasive particles;
an inorganic salt;
an oxidizing agent;
an inorganic acid; and
water.

2. The polishing composition according to claim 1, wherein the positively-charged abrasive particles are at least one selected from the group consisting of alumina particles, surface-modified alumina particles, ceria particles, surface-modified positively-charged silica particles, titania particles, and zirconia particles.

3. The polishing composition according to claim 1, wherein the positively-charged abrasive particles are contained in the polishing composition in an amount of 0.01% to 50% by mass of the polishing composition.

4. The polishing composition according to claim 1, wherein the inorganic salt is at least one selected from the group consisting of a salt containing a chloride ion, a salt containing a bromide ion, and a salt of a hydroacid.

5. The polishing composition according to claim 1, wherein the inorganic salt is at least one selected from the group consisting of a chloride salt containing an ammonium ion, a chloride salt containing an alkali metal ion, a chloride salt containing an alkali earth metal ion, a salt of hydrochloric acid other than the aforementioned chloride salts, a bromide salt containing an ammonium ion, a bromide salt containing an alkali metal ion, a bromide salt containing an alkali earth metal ion, a salt of hydrobromic acid other than the aforementioned bromide salts, a salt of chloroauric acid, a salt of chloroplatinic acid, a salt of bromoauric acid, and a salt of bromoplatinic acid.

6. The polishing composition according to claim 1, wherein the inorganic salt is contained in the polishing composition in an amount of 1 μmol/L to 3 mol/L of the polishing composition.

7. The polishing composition according to claim 1, where the oxidizing agent is at least one selected from the group consisting of ozone, hydrogen peroxide, an alkali metal peroxide, an alkali earth metal peroxide, benzoyl peroxide, ammonium peroxydisulfate, potassium peroxydisulfate, sodium peroxydisulfate, nitrous oxide, and an organic peroxyacid.

8. The polishing composition according to claim 1, wherein the oxidizing agent is contained in the polishing composition in an amount of 10 mmol/L to 3 mol/L of the polishing composition.

9. The polishing composition according to claim 1, wherein the polishing composition has an acidic pH.

10. The polishing composition according to claim 1, wherein the inorganic acid is at least one selected from the group consisting of hydrochloric acid, chloroauric acid, chloroplatinic acid, hypochlorous acid, chlorous acid, chloric acid, perchloric acid, hydrobromic acid, bromoauric acid, bromoplatinic acid, hypobromous acid, bromous acid, bromic acid, perbromic acid, and nitric acid.

11. A method for polishing a substrate containing a noble metal layer, the method comprising:
preparing a polishing composition containing:
positively-charged abrasive particles;
an inorganic salt;
an oxidizing agent;
an inorganic acid; and
water; and
polishing the noble metal layer of the substrate using the polishing composition.
